(19) United States
(12) Patent Application Publication
(10) Pub. No.: US 2026/0076458 A1
(43) Pub. Date: Mar. 19, 2026

(54) Cell Phone Ring Bracket

(71) Applicant: Xinyao Cai, Lufeng (CN)

(72) Inventor: Xinyao Cai, Lufeng (CN)

(21) Appl. No.: 18/977,596

(22) Filed: Dec. 11, 2024

(30) Foreign Application Priority Data
Sep. 14, 2024 (CN) 2024222629490

(51) Int. Cl. A44C 9/00; F16M 13/04; H04M 1/04

(52) U.S. Cl. CPC A44C 9/0061; F16M 13/04; H04M 1/04

(57) ABSTRACT

The invention discloses the cell phone ring bracket designed for use on the pinky thumb, comprising the ring with the storage slot on its outer surface. Within this slot is the arc-shaped bracket that can be hinged and embedded into the slot. The storage slot has first and second hinged holes that allow insertion of the axle pin to ensure the arc-shaped bracket is securely connected to the ring. The first end of the storage slot features the inclined surface for supporting the bracket, while the second end includes the notch to facilitate the extraction of the bracket. When the bracket is unfolded by pressing against the inclined surface, it transitions to the usable state. This configuration allows the cell phone to be positioned on the arc-shaped bracket, providing support and positioning, easing the pressure exerted on the pinky thumb.

### TECHNICAL FIELD

This invention herein relates to the technical field of finger bracket of cell phone, particularly relates to the cell phone ring bracket.

### BACKGROUND OF THE PRESENT INVENTION

The size of the cell phone in the market is relatively large and with not-low weight, when holding the cell phone, the pinky thumb need to open to support the bottom of the cell phone; the weight of the phone on the pinky thumb generates pressure; after long time use of the phone, the pinky thumb will produce pain, numbness, or even deformation; cell phone bracket are being sold in the market but there is no cell phone bracket for the pinky thumb; the sold bracket did not narrow the force of the pinky thumb nor play the role of protection of the pinky thumb; moreover, the cell phone bracket in market is either large in size and not easy to store, or it is basically installed on the back of the cell phone in the form of structure, which will increase the thickness of the phone, and also lead to the back of the phone is not flat; the structure design is not reasonable enough, so it can't be used as the ring and other daily accessories.

Therefore, the problem is how to achieve the clever and reasonable design, which can be used as the daily accessory ring, and as the cell phone bracket realizing its multi-functional, being easy and convenient in use and practical; its size should be compact not taking up space and easy to wear and storage; it also plays the supportive role to the cell phone to narrow the cell phone's force to the pinky thumb; when long-term use of the phone, the pinky thumb will not produce pain or deformation; it has the protective effect to users'pinky thumb; and arc-shaped bracket on the phone has the positioning effect, so that the phone is not easy to shift, not easy to fall; also, it is the urgently problem to solve in the industry that the cell phone ring bracket has the protective effect on the cell phone.

### SUMMARY OF PRESENT INVENTION

The main purpose of this invention is to provide the cell phone ring bracket, aims to achieve the clever and reasonable design, which can be used as the daily accessory ring, and as the cell phone bracket realizing its multi-functional, being easy and convenient in use and practical; its size should be compact not taking up space and easy to wear and storage; it also plays the supportive role to the cell phone to narrow the cell phone's force to the pinky thumb; when long-term use of the phone, the pinky thumb will not produce pain or deformation; it has the protective effect to users'pinky thumb; and arc-shaped bracket on the phone has the positioning effect, so that the phone is not easy to shift, not easy to fall; also, it is the urgently problem to solve in the industry that the cell phone ring bracket has the protective effect on the cell phone.

The invention proposes the cell phone ring bracket, including the ring that can be set on the pinky thumb; the ring is equipped with the storage slot on the outer surface; the cell phone ring bracket also includes the hinged in the storage slot and can be embedded in the storage slot in the arc of the bracket; the storage slot is equipped with two first hinged holes at the end of the first end of the arc of the bracket is equipped with the end of the first hinged hole and the first hinged holes corresponds to the adaption of the second hinge holes; the first hinged holes and the second hinged holes are inserted into the axle pin so that the arc-shaped bracket is hingedly connected with the ring; the first end of the storage slot is provided with the inclined surface that has the supporting effect on the arc-shaped bracket, and the second end of the storage slot is provided with the notch that is convenient for gouging out the arc-shaped bracket; the ring is set on the pinky thumb, and the arc-shaped bracket is gouged out and unfolded, so that the arc-shaped bracket is converted to use status by pressing the arc-shaped bracket against the inclined surface; the cell phone is set on the arc-shaped bracket; the arc-shaped bracket on the cell phone to play the role of positioning and support to slow down the cell phone on the role of the pinky thumb; the pinky thumb does not need to open to hold the bottom of the cell phone.

Preferably, the ring is provided with lots of decorative patterns.

Preferably, the recess notch is provided as the circular notch or the V-shaped notch.

Preferably, the ring is made of metal or plastic.

Preferably, the curved bracket is made of metal or plastic.

This invention achieves the clever and reasonable design, which can be used as the daily accessory ring, and as the cell phone bracket realizing its multi-functional, being easy and convenient in use and practical; its size should be compact not taking up space and easy to wear and storage; it also plays the supportive role to the cell phone to narrow the cell phone's force to the pinky thumb; when long-term use of the phone, the pinky thumb will not produce pain or deformation; it has the protective effect to users'pinky thumb; and arc-shaped bracket on the phone has the positioning effect, so that the phone is not easy to shift, not easy to fall; also, it is the urgently problem to solve in the industry that the cell phone ring bracket has the protective effect on the cell phone.

### BRIEF DESCRIPTION OF THE DRAWINGS

FIG. 1 shows the first of the three three-dimensional structural schematic diagrams of the embodiment of the cell phone ring bracket of the invention;

FIG. 2 shows the second of the three three-dimensional structural schematic diagrams of the embodiment of the cell phone ring bracket of the invention;

FIG. 3 shows the third of the three three-dimensional structural schematic diagrams of the embodiment of the cell phone ring bracket of the invention;

FIG. 4 shows the first of the three three-dimensional structural decomposition schematic diagrams of the embodiment of the cell phone ring bracket of the invention;

FIG. 5 shows the second of the three three-dimensional structural decomposition schematic diagrams of the embodiment of the cell phone ring bracket of the invention;

FIG. 6 shows the third of the three three-dimensional structural decomposition schematic diagrams of the embodiment of the cell phone ring bracket of the invention; The realization of the purpose, functional features and advantages of the invention will be further described in connection with the embodiments and with reference to the accompanying drawings.

### DETAILED DESCRIPTION OF THE EMBODIMENT'S

It should be understood that the specific embodiments described herein are intended only to explain the invention and are not intended to limit the invention.

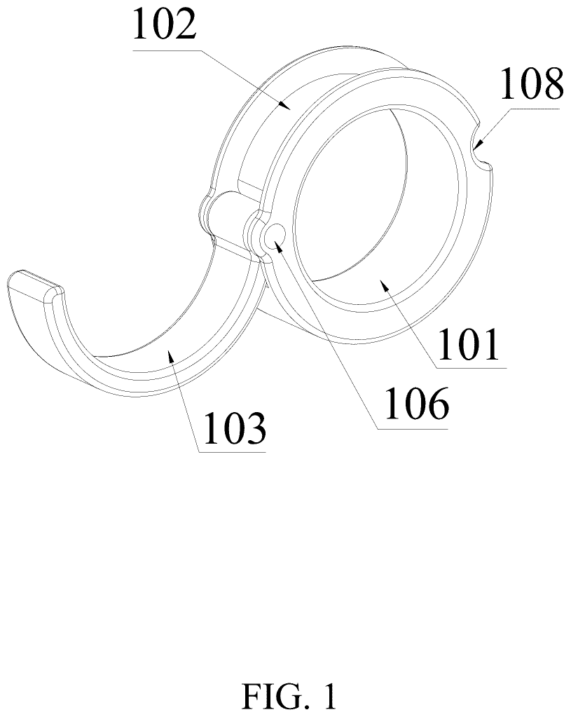

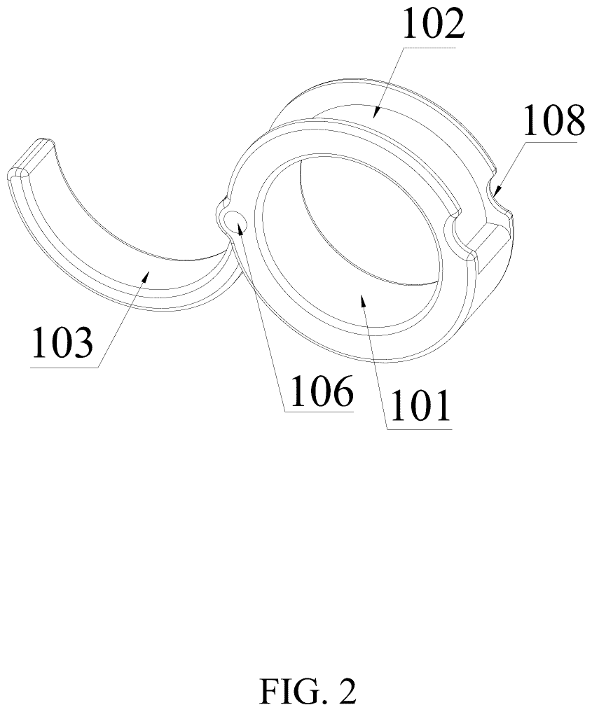

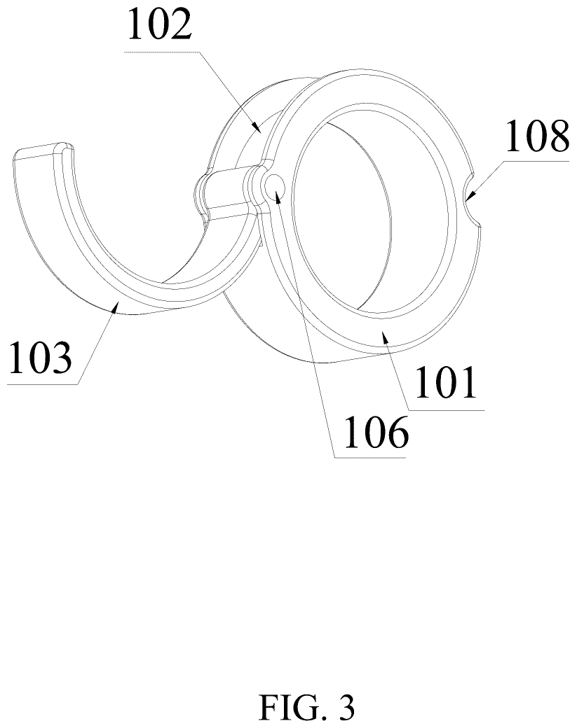

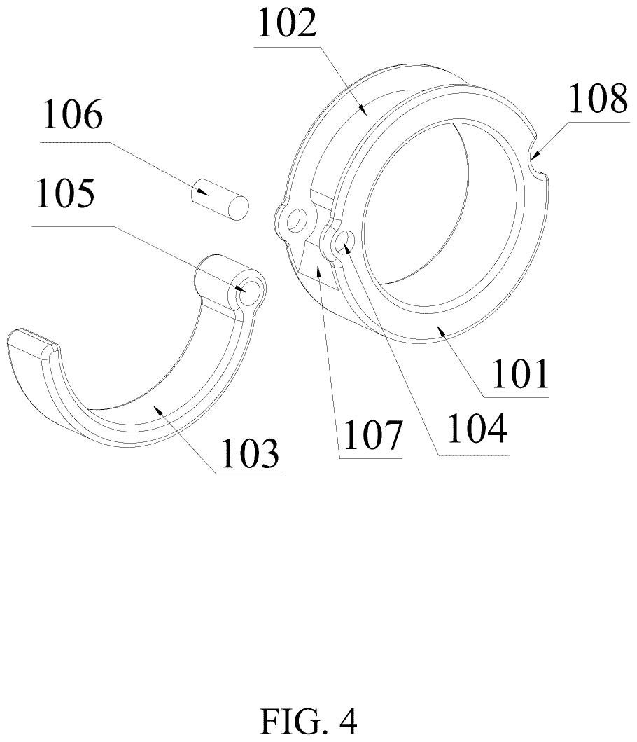

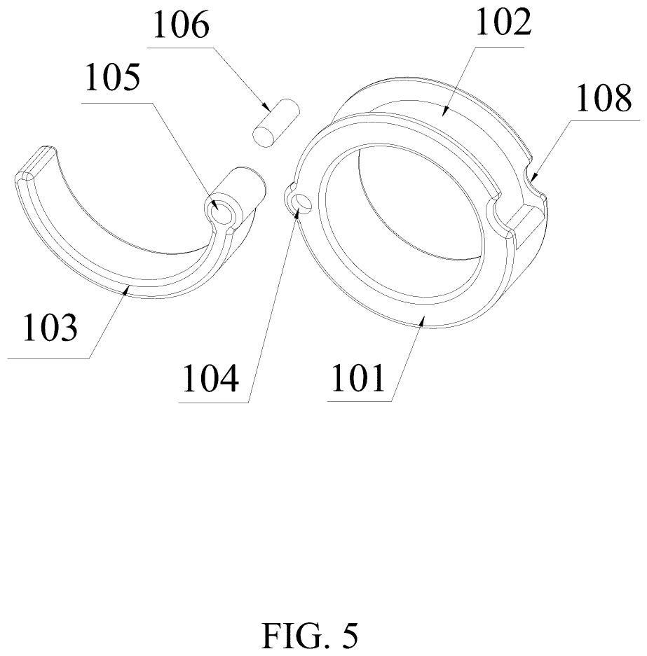

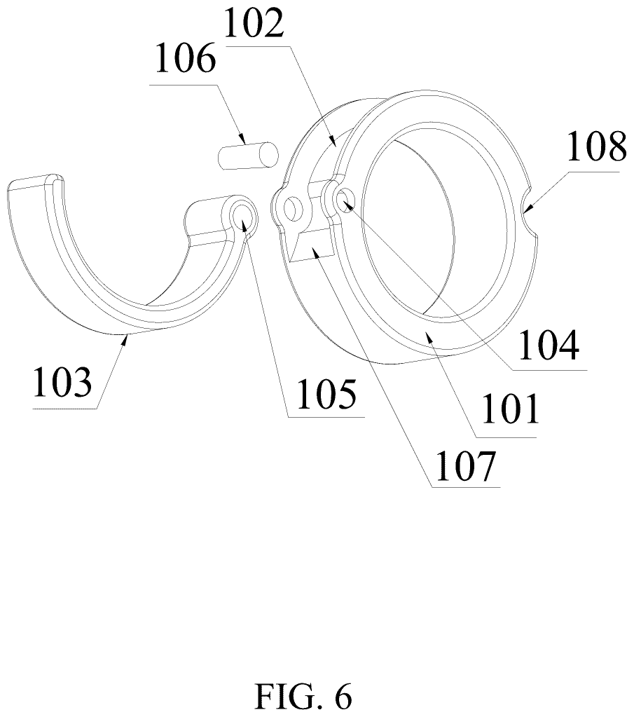

Referring to FIGS. 1-6, the embodiment of the cell phone ring bracket of the invention is presented, comprising the ring 101 in the shape of the annulus that can be set on the pinky thumb; stowage card slot 102 is set on the outer face of the ring 101; and the cell phone ring bracket further comprising the curved arc-shaped bracket 103 hingedly attached to the stowage card slot 102 and snap-embeddable in the stowage card slot 102.

Two first hinged holes 104 are provided at the first end of the storage card slot 102; the second hinged hole 105 is provided at the end of the curved bracket 103; at the end of the arc-shaped bracket 103, there is the second hinge hole 105 that corresponds to the first hinge hole 104 and is adapted accordingly; the axle pin 106 is inserted in the first hinged hole 104, the second hinged hole 105 so that the curved bracket 103 is hingedly coupled with the ring 101.

The inclined surface 107 is set at the first end of the stowage card slot 102 and has the supportive effect on the curved bracket 103; the notch 108 is set at the second end of the stowage card slot 102 and facilitates gouging out the curved bracket 103.

The ring 101 set on the pinky thumb; key out the arc-shaped bracket 103 and expand the arc-shaped bracket 103 and inclined surface 107 against the conversion into use; the cell phone set on the arc-shaped bracket 103; the arc-shaped bracket 103 on the cell phone plays the role in positioning and supporting the cell phone to narrow the force of the cell phone on the pinky thumb; the small pinky thumb does not need to open to support the bottom of the cell phone, which can be avoided after prolonged use of the cell phone.

The ring 101 is provided with lots of decorative patterns, which can be designed according to preferences and needs, so that the style of the ring phone bracket is flexible and diverse, and can meet the individual needs of men and women, old and young.

The notch 108 is set as the circular notch or the V-shaped notch. It is also possible to set the notch in other shapes as required.

The ring 101 is made of metal or plastic, or may be made of other materials.

The curved bracket 103 is made of metal or plastic, and may be made of other materials.

Under normal circumstances, this cell phone ring bracket is the decorative ring, worn on the pinky thumb or other fingers; when you need to use the cell phone, it can be converted into the cell phone bracket; the ring 101 set on the pinky thumb; key out the arc-shaped bracket 103 and expand the arc-shaped bracket 103 and inclined surface 107 against the conversion into use; the cell phone set on the arc-shaped bracket 103; the arc-shaped bracket 103 on the cell phone plays the role in positioning and supporting the cell phone to narrow the force of the cell phone on the pinky thumb; the small pinky thumb does not need to open to support the bottom of the cell phone, which can be avoided after prolonged use of the cell phone; being easy and convenient in use and practical; its size should be compact not taking up space and easy to wear and storage; it also plays the supportive role to the cell phone to narrow the cell phone's force to the pinky thumb; when long-term use of the phone, the pinky thumb will not produce pain or deformation; it has the protective effect to users'pinky thumb; and arc-shaped bracket on the phone has the positioning effect, so that the phone is not easy to shift, not easy to fall; also, it is the urgently problem to solve in the industry that the cell phone ring bracket has the protective effect on the cell phone.

In addition to the need to read books, key out the arc-shaped bracket 103 and expand the arc-shaped bracket 103 and the inclined surface 107 against the conversion to use the state and set the book up in the arc-shaped bracket 103; the arc-shaped bracket 103 supports on the bottom of the book and plays the role in positioning and supporting of the book in order to narrow the force on the pinky thumb to pick up the book to read, so that the small pinky thumb does not need to open to hold the bottom of the book.

This invention realizes the ingenious and reasonable design, can be used as a daily accessory ring, and also be used as the cell phone bracket or book reading bracket; it is multi-functional, easy and convenient in use and practical; its size should be compact not taking up space and easy to wear and storage; it also plays the supportive role to the cell phone to narrow the cell phone's force to the pinky thumb; when long-term use of the phone, the pinky thumb will not produce pain or deformation; it has the protective effect to users'pinky thumb; and arc-shaped bracket on the phone has the positioning effect, so that the phone is not easy to shift, not easy to fall; also, it is the urgently problem to solve in the industry that the cell phone ring bracket has the protective effect on the cell phone.

The above is only one preferred embodiment of the invention, not to limit the scope of the patent of the invention, all the equivalent structural transformation using the invention specification and the accompanying drawings, or directly or indirectly in other related technical fields, are included in the scope of patent protection of the invention herein.

What is claimed is

1. A cell phone ring bracket, comprising:
a ring configured to be wore on a little pinky thumb of a user's hand;
a storage slot provided on an outer surface of the ring; wherein the storage slot comprises a pair of first hinge holes;
an arc-shaped bracket hinged at a first end of the storage slot, and configured to be embedded in the storage slot, wherein the arc-shaped bracket comprises a second hinge hole;
wherein, the pair of first hinge holes are provided at the first end of the storage slot;
wherein the second hinge hole is provided at a first end of the arc-shaped bracket corresponding to the pair of first hinge holes; and
an axle pin inserted into the pair of first hinge holes and the second hinge hole to hingedly connect the arc-shaped bracket with the ring;
wherein the storage slot is provided with an inclined surface at the first end to support the arc-shaped bracket; the storage slot is provided with a notched notch at a second end of the arc-shaped bracket that facilitates keying out the arc-shaped bracket from the storage slot;
wherein, the arc-shaped bracket, key out and expands from the storage slot and gets inclined against the ring for accommodation of a cell phone held in the user's hand,
thereby eliminating the need of user's pinky thumb to hold bottom of the cell phone.

2. The cell phone ring bracket according to claim 1, wherein the ring is provided with massive decorative patterns.

3. The cell phone ring bracket according to claim 1, wherein the notch is provided as circular notch or v-shaped notch.

4. The cell phone ring bracket according to claim 1, wherein the ring is made of metal or plastic.

5. The cell phone ring bracket according to claim 1, wherein the arc-shaped bracket is made of metal or plastic.
